(19) United States
(12) Patent Application Publication
(10) Pub. No.: US 2021/0264328 A1
(43) Pub. Date: Aug. 26, 2021

(54) SERVER, VEHICLE DISPATCH METHOD, NON-TRANSITORY COMPUTER READABLE MEDIUM, AND VEHICLE DISPATCH SYSTEM

(71) Applicant: TOYOTA JIDOSHA KABUSHIKI KAISHA, Toyota-shi (JP)

(72) Inventors: Yuki TATSUMOTO, Nagoya-shi (JP); Saori MATSUMOTO, Chofu-shi (JP); Keigo YAMADA, Toyota-shi (JP); Akira SASAKI, Miyoshi-shi (JP); Mitsuhiro MIURA, Toyota-shi (JP)

(73) Assignee: TOYOTA JIDOSHA KABUSHIKI KAISHA, Toyota-shi (JP)

(21) Appl. No.: 17/187,171

(22) Filed: Feb. 26, 2021

(30) Foreign Application Priority Data
Feb. 26, 2020 (JP) 2020-030839

(51) Int. Cl. G06Q 10/02; G06Q 10/06; G06Q 50/30; G08G 1/00; G08G 1/01; G06K 9/00

(52) U.S. Cl. CPC G06Q 10/02; G06Q 10/06311; G06K 9/00798; G08G 1/202; G08G 1/0145; G06Q 50/30

(57) ABSTRACT

A server includes a communication interface configured to communicate with an information terminal in the possession of a user; and a controller configured to manage operation schedule information for one or more vehicles. The communication interface is configured to receive boarding request information from the information terminal in the possession of the user. The boarding request information includes a desired boarding location, a desired alighting location, and a desired boarding time and/or a desired alighting time of the user. The controller is configured to determine, for a vehicle that can be used by the user, a potential boarding location and a potential alighting location, and a potential boarding time and a potential alighting time, based on the operation schedule information, the boarding request information, and road condition information indicating a condition of a road in the vicinity of the desired boarding location and the desired alighting location.

### CROSS-REFERENCE TO RELATED APPLICATION

This application claims priority to Japanese Patent Application No. 2020-030839 (filed on Feb. 26, 2020), the entire contents of which are incorporated herein by reference.

### TECHNICAL FIELD

The present disclosure relates to a server, a vehicle dispatch method, a non-transitory computer readable medium, and a vehicle dispatch system.

### BACKGROUND

Vehicles that operate in accordance with demand from users are known. For example, Patent Literature (PTL) 1 discloses a method of dispatching an on-demand bus for improving operation efficiency.

### CITATION LIST

### Patent Literature

PTL 1: JP 2019-016290 A

### SUMMARY

For vehicles that operate in accordance with demand from the users, it is sometimes impossible or difficult for the vehicles to stop at desired boarding or alighting locations of the users depending on road conditions. If stopping the vehicles is not accomplished in a smooth manner, the operation efficiency of the vehicles may decrease.

It would be helpful to enable smooth stopping for boarding and alighting of users to thereby improve the operation efficiency of the vehicles.

A server according to an embodiment of the present disclosure includes:

a communication interface configured to communicate with an information terminal in the possession of a user; and

a controller configured to manage operation schedule information for one or more vehicles, wherein

the communication interface is configured to receive boarding request information from the information terminal in the possession of the user, the boarding request information including a desired boarding location, a desired alighting location, and a desired boarding time and/or a desired alighting time of the user, and

the controller is configured to determine, for a vehicle that can be used by the user, a potential boarding location and a potential alighting location, and a potential boarding time and a potential alighting time, based on the operation schedule information, the boarding request information, and road condition information indicating a condition of a road in the vicinity of the desired boarding location and the desired alighting location.

A vehicle dispatch method according to an embodiment of the present disclosure includes:

receiving boarding request information from an information terminal in the possession of a user, the boarding request information including a desired boarding location, a desired alighting location, and a desired boarding time and/or a desired alighting time of the user; and

determining, for a vehicle that can be used by the user, a potential boarding location and a potential alighting location, and a potential boarding time and a potential alighting time, based on operation schedule information for one or more vehicles, the boarding request information, and road condition information indicating a condition of a road in the vicinity of the desired boarding location and the desired alighting location.

A program according to an embodiment of the present disclosure is configured to cause a processor to execute operations including:

receiving boarding request information from an information terminal in the possession of a user, the boarding request information including a desired boarding location, a desired alighting location, and a desired boarding time and/or a desired alighting time of the user; and

determining, for a vehicle that can be used by the user, a potential boarding location and a potential alighting location, and a potential boarding time and a potential alighting time, based on operation schedule information for one or more vehicles, the boarding request information, and road condition information indicating a condition of a road in the vicinity of the desired boarding location and the desired alighting location.

A vehicle dispatch system according to an embodiment of the present disclosure includes:

the server according to any of the above; and

vehicles operation of each of which is managed based on the operation schedule information of the server.

The server, the vehicle dispatch method, the non-transitory computer readable medium, and the vehicle dispatch system according to the embodiment of the present disclosure enable smooth stopping for boarding and alighting of the users, thereby improving the operation efficiency of the vehicles.

### BRIEF DESCRIPTION OF THE DRAWINGS

In the accompanying drawings:

FIG. 1 is a schematic diagram illustrating a configuration example of a vehicle dispatch system according to an embodiment;

FIG. 2 is a block diagram illustrating a configuration example of the vehicle dispatch system according to the embodiment;

FIG. 3 illustrates an example of operation schedule information for vehicles;

FIG. 4 is a flowchart illustrating an example of a procedure executed by a server;

FIG. 5 is a flowchart illustrating an example of processing for determining a potential boarding location and a potential alighting location in the flowchart of FIG. 4; and

FIG. 6 illustrates an example of proposal information displayed on an information terminal.

### DETAILED DESCRIPTION

An embodiment of the present disclosure will be described below, with reference to the drawings. The drawings used in the following description are schematic. Dimensional ratios or the like on the drawings do not necessarily coincide with actual ones.

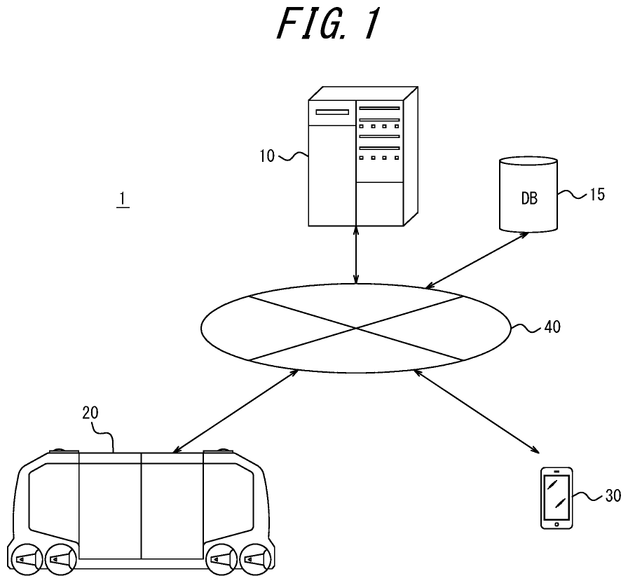

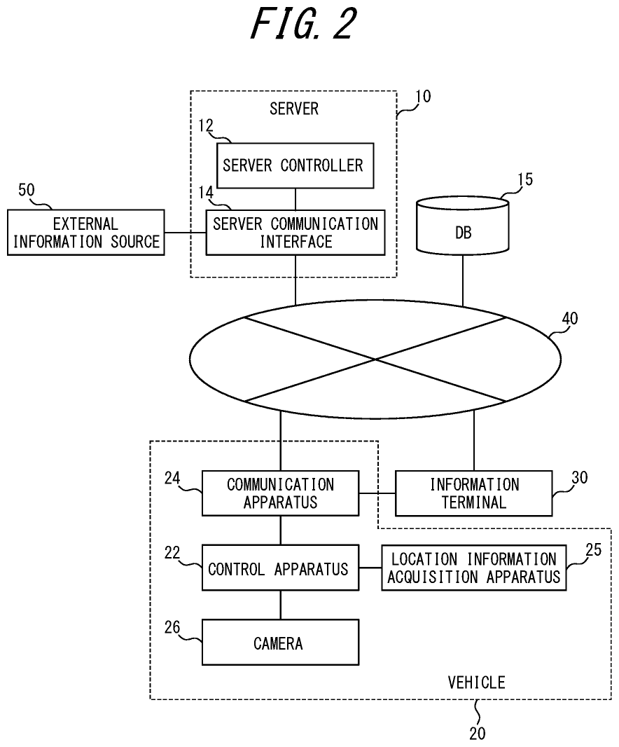

As illustrated in FIGS. 1 and 2, a vehicle dispatch system 1 according to the embodiment includes a server 10, a vehicle 20, and an information terminal 30. The server 10, the vehicle 20, and the information terminal 30 are connected to a network 40 and are communicable with each other. A database (DB) 15 is also connected to the network 40, but this is not required. Each of the server 10, the vehicle 20, the information terminal 30, and the DB 15 is not limited to one and may be two or more in number. The vehicle dispatch system 1 may include the DB 15. The DB 15 may include an external database that is not included in the vehicle dispatch system 1.

(Configuration and Operations of Server)

The server 10 manages an operational schedule of the one or more vehicles 20. Operation schedule information includes information for each vehicle 20 regarding a plurality of stopping locations and stopping times on an operation route of the vehicle 20. The server 10 is configured to communicate with the information terminal 30 of a user and receive from the user a reservation for boarding the vehicle 20. Herein, a person who uses the vehicle dispatch system 1 is referred to as the “user”, and a person who boards the vehicle 20 is referred to as a “passenger”. The “user” is encompassed in the “passenger” when the “user” boards the vehicle 20 by using the vehicle dispatch system 1.

The server 10 may manage operation of the vehicle 20 so that the user can board the vehicle 20. The server 10 dispatches the vehicle 20 that the user is to board based on the reservation from the user. The server 10 may control the operation route or the operation schedule of the vehicle 20 that the user is to board. The server 10 may determine the operation schedule of the vehicle 20 based on the reservation from the user. The service for operating the vehicle 20 and letting the user board the vehicle 20 based on the reservation from the user is also referred to as an on-demand bus service. The vehicle dispatch system 1 is capable of providing the on-demand bus service.

The server 10 may include a single server apparatus, or a plurality of server apparatuses capable of communicating with each other. The server 10 may be operated, for example, by an entity providing the on-demand bus service. The server 10 manages the user's reservation for boarding the vehicle 20. The server 10 may transmit and receive various types of information related to the on-demand bus service to and from the vehicle 20. The server 10 may be configured to execute, in addition to the above processing, various types of processing related to the on-demand bus service. The server 10 may communicate with the vehicle 20 to thereby acquire various types of information related to the vehicle 20, such as a location or a speed of the vehicle 20.

The server 10 includes a server controller 12 and a server communication interface 14. The server controller 12 is also referred to simply as a controller. The server controller 12 may include at least one processor. The “processor” in the present embodiment may be, but is not limited to, a general-purpose processor, or a dedicated processor that is dedicated to specific processing. The server controller 12 may include at least one dedicated circuit. The dedicated circuit may include, for example, a Field-Programmable Gate Array (FPGA) and an Application Specific Integrated Circuit (ASIC). The server controller 12 may include the dedicated circuit instead of the processor, or may include the dedicated circuit along with the processor. The server communication interface 14 is also referred to simply as a communication interface. The server communication interface 14 includes a communication module and may communicate with the vehicle 20.

The server 10 may further include a memory. The memory may be, but is not limited to, a semiconductor memory, a magnetic memory, or an optical memory. The memory may function as, for example, a main memory, an auxiliary memory, or a cache memory. The memory may include an electromagnetic storage medium, such as a magnetic disc. The memory may store any information used for the operations of the server 10. For example, the memory may store a system program, an application program, or the like. The server 10 may store a program, information, or the like, using the DB 15 as the memory. The memory may be included in the server controller 12.

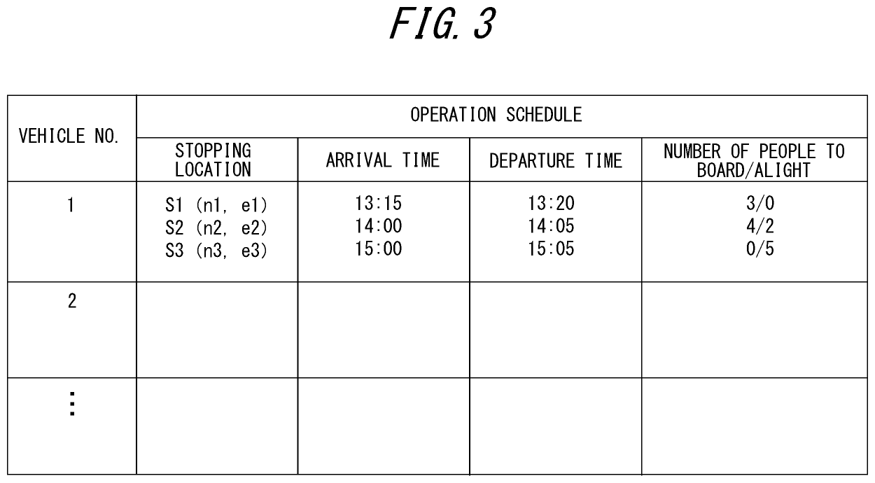

The server 10 stores the operation schedule information for the vehicle 20 in the DB 15 or in the memory of the server 10. The server 10 may search the operation schedule information for a plurality of the vehicles 20 in accordance with predetermined conditions. When the operation schedule information is stored in the DB 15, the server 10 can search the operation schedule information in the DB 15 in accordance with the predetermined conditions. The operation schedule information includes information for each vehicle 20 regarding stopping locations and stopping times on the route along which the vehicle 20 is scheduled to travel. The stopping times include arrival times and departure times. FIG. 3 illustrates an example of the operation schedule information. In the example of FIG. 3, the operation schedule information includes information for each vehicle 20 regarding the stopping locations, the arrival times at the stopping locations, the departure times from the stopping locations, the numbers of people who are to board and alight, etc. on the route along which the vehicle 20 is scheduled to travel. The format of the operation schedule information is not limited to the example, and various formats may be adopted.

The operation schedule of the vehicle 20 may be set with extra time to be able to accommodate boarding requests from users other than the user who has already made the reservation for the vehicle 20. For example, in the operation schedule illustrated in FIG. 3, the server controller 12 can later set a new stopping location at a time between Stop Location 51 and Stop Location S2, the two stopping locations for Vehicle No. 1. In that case, the server controller 12 can reduce the impact on the overall schedule produced by the increase in the number of stopping locations by, for example, reducing a stopping time period by adjusting the departure time from Stopping Location 51 and the arrival time at Stopping Location S2.

The server 10 may further store user information and road condition information in the DB 15 or in the memory of the server 10. The user information includes user identification information identifying each user. The user identification information can be referred to as a user ID. The user identification information may be stored in association with different user information, such as a user name, contact information, or billing information. When the vehicle dispatch system 1 provides an incentive to the user according to a user's past record of usage, the user information may include incentive information related to the incentive associated with the user identification information.

The road condition information includes, for example, regulatory information, congestion information, and map information.

The regulatory information is information related to a regulation for stopping on a road. The regulatory information includes information regarding a location or an area on the road in which stopping is permanently or temporarily prohibited. Locations at which stopping is permanently prohibited include, for example, locations with a parking prohibited sign, inside a tunnel, with a steep slope, and the like. Locations at which stopping is temporarily prohibited include locations at which road construction occurs, and areas at which an event such as a marathon is held. The information regarding the temporary prohibition of stopping includes information regarding times at which stopping is prohibited. The server controller 12 may acquire the regulatory information from an external information source 50, such as a traffic information service provider that is not included in the vehicle dispatch system 1.

The congestion information indicates a congestion condition of the road. The congestion information includes information regarding a location or an area on the road in which congestion frequently occurs and regarding a location or an area on the road in which many vehicles are parked on a road shoulder. The server 10 prevents stopping of the vehicle 20 in the location or the area in which congestion frequently occurs, as this may further exacerbate the congestion. Since the vehicle 20 may not be able to stop, the server 10 avoids stopping by the vehicle 20 in the location or the area in which many vehicles are parked on the road shoulder. The congestion information may include information statistically processed from past information.

The server 10 may collect the congestion information by any method. The server controller 12 may be configured to receive the congestion information from the plurality of vehicles 20 via the server communication interface 14. For example, the plurality of vehicles 20 may each determine congestion for transmission to the server 10, based on the time actually taken to travel along the road. Alternatively, the plurality of vehicles 20 may each acquire a surrounding image during operation to determine congestion and parked vehicles for transmission to the server 10. The server controller 12 may acquire the congestion information from the external information source 50, such as the traffic information service provider that is not included in the vehicle dispatch system 1. The server controller 12 may store the congestion condition of the road in the past and may retain, in the memory, information indicating, for each day and for each time of day, a location having a high probability of congestion, as the congestion information.

The map information includes road information for an area in which the dispatch system 1 provides the service, along with geographical information. The map information includes information regarding the presence of a parking strip on the road, a road width, and/or a road shoulder width. The map information may also include information, such as the number of lanes on the road, or the presence of a right-turn lane in front of an intersection. The regulatory information and the congestion information may be associated with the map information. Information regarding a location at which parking of the vehicles 20 is easily accomplished, a location at which parking is prohibited, or the like may be stored in advance in association with the map information.

The server communication interface 14 can receive, from the information terminal 30 in the possession of the user, boarding request information indicating a desired boarding location, a desired alighting location, and a desired boarding time and/or a desired alighting time of the user using the vehicle dispatch system 1. The desired boarding location and the desired boarding time refer to the location and the time at which the user desires to board the vehicle 20. The desired alighting location and the desired alighting time refer to the location and the time at which the user desires to alight from the vehicle 20.

Based on the boarding request information received from the information terminal 30, the operation schedule information, and the road condition information in the vicinity of the desired boarding location and the desired alighting location, the server controller 12 can determine a potential boarding location and a potential alighting location for the vehicle 20 that can be used by the user. The server controller 12 may further determine a potential boarding time and a potential alighting time.

The server controller 12 may be configured to determine an impact on traffic on the road produced when the vehicle 20 stops at any location on the road based on the road condition information. The server controller 12 may be configured to determine the potential boarding location and the potential alighting location so as to reduce the impact produced by stopping by the vehicle 20 on the traffic on the road. The determination of the impact on the traffic considers information included in the road condition information, such as the location of the congestion as included in the congestion information, or the presence of the parking strip, and the road width and the road shoulder width as included in the map information.

The server controller 12 may transmit, to the information terminal 30, proposal information including information indicating the determined potential boarding location and the determined potential alighting location, and the determined potential boarding time and the determined potential alighting time via the server communication interface 14. Upon receiving response information indicating acceptance of the proposal information from the information terminal 30, the server controller 12 can establish a reservation for the vehicle 20 that can be used by the user pertaining to the proposal information.

After establishing the reservation for the vehicle 20, the server controller 12 can determine that the incentive is to be provided to the user based on the desired boarding location, the desired alighting location, and the desired boarding time and/or the desired alighting time that are included in the boarding request information, and the potential boarding location, the potential alighting location, and the potential boarding time and/or the potential alighting time.

Regarding the vehicle 20 that has already been reserved by one or more users, setting new boarding and alighting locations on the scheduled operation route may produce a need to adjust the operation schedule. The server controller 12 may notify the information terminal 30 of each user who has made the reservation of the fact that a scheduled boarding time or a scheduled alighting time has been adjusted when the new stopping locations have been set and when the need has arisen to adjust the operation schedule.

(Configuration and Operation of Vehicle)

The vehicle 20 is, for example, but is not limited to, a passenger transportation vehicle, such as a bus used in the on-demand bus service, and may be any vehicle that the user can use as a passenger. The vehicle 20 is not limited to one and may be two or more in number. The vehicle 20 may be a vehicle that can operate using automated driving. The automated driving may be, for example, performed at any level from Level 1 to Level 5 as defined by the Society of Automotive Engineers (SAE). The automated driving may be performed based on other definitions without being limited to the exemplified definition.

As illustrated in FIG. 2, the vehicle 20 includes a control apparatus 22 and a communication apparatus 24. The control apparatus 22 and the communication apparatus 24 are communicably connected to each other, for example, via an in-vehicle network, such as a Controller Area Network (CAN), or a dedicated line.

The control apparatus 22 controls individual components included in the vehicle 20. The control apparatus 22 may include at least one processor. The control apparatus 22 may include at least one dedicated circuit instead of the processor, or may include at least one dedicated circuit along with the processor. The control apparatus 22 may further include a memory.

The operation of the vehicle 20 is managed based on the operation schedule information stored in the memory of the server 10 or in the DB 15. The vehicle 20 may store, in the memory of the control apparatus 22, the vehicle 20's own operation schedule information. The vehicle 20's own operation schedule information is equal to part of the operation schedule information managed by the server 10. The vehicle 20 may include a different storage apparatus than the memory of the control apparatus 22 and may store the vehicle 20's own operation schedule information in the storage apparatus. The vehicle 20's own operation schedule information may include the plurality of stopping locations on the operation route of the vehicle 20 itself, the arrival times at the stopping locations, and the departure times from the stopping locations, in a similar manner to the operation schedule information of FIG. 3. The vehicle 20's own operation schedule information may include the information regarding the number of people who are scheduled to board or alight at each stopping location. The vehicle 20 enables the passengers to board or alight at the plurality of stopping locations on the operation route in accordance with the operation schedule information.

The communication apparatus 24 communicates with the server 10 via the network 40. The communication apparatus 24 may communicate with the information terminal 30 via the network 40, or may communicate with the information terminal 30 without using the network 40. The communication apparatus 24 may be, for example, an in-vehicle communication device. The communication apparatus 24 may include a communication module to connect with the network 40. The communication module may include, but is not limited to, a communication module compatible with mobile communication standards, such as the 4^{th} Generation (4G) standard or the 5^{th} Generation (5G) standard. The communication apparatus 24 may be configured to communicate with the information terminal 30 through Near Field Communication (NFC), Bluetooth® (Bluetooth is a registered trademark in Japan, other countries, or both), or the like.

The communication apparatus 24 can transmit and receive various types of information to and from the server communication interface 14 of the server 10. For example, the communication apparatus 24 can transmit the congestion information to the server communication interface 14. The server communication interface 14 can also transmit, to the communication apparatus 24, information that enables the user to board. The information that enables the user to board includes the vehicle 20's own operation schedule information that is updated by the reservation from the user, and information that the control apparatus 22 of the vehicle 20 can use to verify the user who has made the reservation. As the information that can be used to verify the user who has made the boarding reservation, the user identification information may be used, for example.

As illustrated in FIG. 2, the vehicle 20 may further include a location information acquisition apparatus 25. The location information acquisition apparatus 25 and other components mounted in the vehicle 20 are connected so as to communicate with each other, via the in-vehicle network such as the CAN, or the dedicated line. The location information acquisition apparatus 25 acquires location information for the vehicle 20. The location information acquisition apparatus 25 may include a receiver compatible with a satellite positioning system. The receiver compatible with the satellite positioning system may include, for example, a Global Positioning System (GPS) receiver. In the present embodiment, the vehicle 20 is assumed to be capable of acquiring the location information for the vehicle 20 itself by using the location information acquisition apparatus 25. The vehicle 20 may transmit the vehicle 20's own location information to the server 10 or the information terminal 30 for which the vehicle 20 is reserved.

The vehicle 20 may further include a camera 26. The camera 26 can capture an image of a condition of the road in the vicinity of the vehicle 20. The camera 26 may include an imaging device to capture an image of visible light, or an imaging device to capture an image of electromagnetic waves other than visible light, such as infrared light. The image captured by the camera 26 is also referred to as an in-vehicle camera image. The control apparatus 22 of the vehicle 20 may be configured to determine the congestion condition from the camera image. The control apparatus 22 may transmit a result of the determination, together with the location information acquired by the location information acquisition apparatus 25, as the congestion information to the server 10 via the communication apparatus 24. The congestion information may include information regarding the congestion on the road, and the number or density of vehicles parked on the road shoulder. The vehicle 20 may transmit the in-vehicle camera image as the congestion information to the server 10 by using the communication apparatus 24. In this case, the congestion condition is determined by the server 10.

(Functions and Operations of Information Terminal)

The information terminal 30 is an information terminal that includes an input/output interface, an information processor, a communication interface, and a location detector. As the information terminal 30, for example, a mobile information terminal, such as a smart phone, may be used. The input/output interface includes, for example, a liquid crystal display with a touch panel. The information terminal 30 can receive an input from the user through the input/output interface and display, to the user, information processed by the information terminal 30. The information processor is configured with a processor. The information processor executes various types of information processing in the information terminal 30. The communication interface is configured with, for example, a wireless communication module compatible with a communication method for the network 40. With the communication interface, the information terminal 30 can communicate with the server 10 via the network 40. The information terminal 30 may communicate with the vehicle 20 via the network 40. The location detector may include a configuration that, for example, is identical or similar to that of the location information acquisition apparatus 25 included in the vehicle 20. The location detector can detect the location of the information terminal 30 itself.

The information terminal 30 may run an application for using the service provided by the vehicle dispatch system 1. In accordance with the application, the information terminal 30 can handle input of information from the user, output of information to the user, and transmission and receipt of information to and from the server 10.

By using the application, the user can specify a point of origin and a destination between which he or she wants to travel using the vehicle 20. The point of origin and the destination may be selected from a display screen, such as a map, on the application of the information terminal 30. The point of origin and the destination can be an area of some extent. The user may further specify both or either of the departure time and the arrival time. When, for example, the user has a certain desired departure time, the user specifies the departure time. When, for example, the user has a certain desired arrival time at the destination, the user specifies the arrival time. The information entered by the user through the application is transmitted to the server 10 as the boarding request information. The information regarding the point of origin and the destination, and the departure time and the arrival time respectively correspond to the desired boarding location and the desired alighting location, and the desired boarding time and the desired alighting time included in the boarding request information.

The information terminal 30 can receive from the server 10 the proposal information in response to the boarding request information via the network 40. Based on the proposal information, the application on the information terminal 30 presents, on the input/output interface, the information regarding the potential boarding location and the potential alighting location, and the potential boarding time and the potential alighting time for the vehicle 20 that the user can board. The user can determine a response to the presented information for transmission to the server 10 from the information terminal 30. When the user accepts the content presented to the information terminal 30, the reservation is established by the server 10.

The information terminal 30 may include a device to communicate with the vehicle 20 without using the network 40. The information terminal 30 may communicate with the vehicle 20 through, for example, NFC, Bluetooth®, or the like. When the user boards the vehicle 20, the information terminal 30 may communicate directly with the vehicle 20 and may transmit and receive information, such as the user identification information, for authenticating whether the vehicle 20 is the vehicle 20 allocated to the user's boarding reservation.

(Vehicle Dispatch Method)

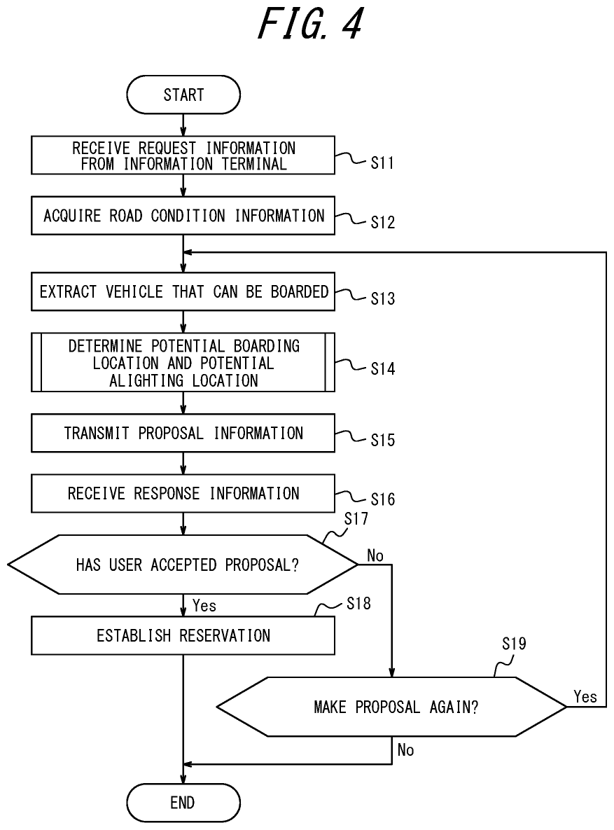

As an example, the server 10 may perform the vehicle dispatch method according to the present disclosure in accordance with a procedure shown in the flowchart illustrated in FIG. 4. The vehicle dispatch method may be implemented as a vehicle dispatch program executed by the server controller 12. The vehicle dispatch program may be stored in a non-transitory computer readable medium. Examples of non-transitory computer readable media may include, but are not limited to, a hard disk, a RAM, a ROM, a flash memory, a CD-ROM, an optical storage device, and a magnetic storage device.

Firstly, the server controller 12 receives, through the server communication interface 14, the boarding request information from the user's information terminal 30 (Step S11). The user can transmit the boarding request information to the server 10 by operating the information terminal 30 in the possession of the user. The desired boarding location and the desired alighting location included in the boarding request information may be specified by information indicating specific places. The desired boarding location and the desired alighting location may each be specified, for example, by an address or by a latitude and a longitude.

The desired boarding location and the desired alighting location may each be specified by information indicating a predetermined area. The predetermined area may be specified, for example, by an address. The predetermined area can be, for example, an area within a predetermined distance range from a specific central location. The predetermined area may be specified as an area extending along the route on which the vehicle 20 operates.

The desired boarding time and the desired alighting time may be specified as specific times. The boarding time and the alighting time may be specified by information indicating allowable ranges of times at which the user actually boards and alights. For example, the information specifying the boarding time and the alighting time may include information indicating how much earlier or later than the time specified by the user the actual time that the user boards the vehicle 20 can be. Specifically, a time span that is allowable by the user may be specified in relation to the time specified by the user.

The server controller 12 acquires the road condition information from the memory of the server 10, the DB 15, and/or the external information source 50 (Step S12). The server controller 12 may acquire the road condition information related to the route leading from the desired boarding location to the desired alighting location of the user.

Based on the desired boarding location and the desired alighting location specified by the user, the server controller 12 extracts the vehicle 20 that can be dispatched in response to the reservation from the user (Step S13). The server controller 12 may select the vehicle 20 that is scheduled to operate on a route passing through the desired boarding location and the desired alighting location specified by the user. The server controller 12 selects the vehicle 20 that can be dispatched while considering the desired boarding time and/or the alighting time specified by the user. The server controller 12 may select the vehicle 20 that is scheduled to operate on the operation route passing through the desired boarding location at a time close to the desired boarding time specified by the user, or the operation route passing through the desired alighting location at a time close to the desired alighting time specified by the user. In a case in which no vehicle 20 is scheduled to operate on the route passing through the desired boarding location and the desired alighting location specified by user at the allowable times, the server controller 12 may newly allocate, to the travel by the user, a vehicle 20 for which no operation schedule is present in the time period and which has not yet been reserved.

Unlike the flowchart of FIG. 4, the server controller 12 may perform Step S13 prior to Step S12. The server controller 12 may perform Step S13 and Step S12 in parallel.

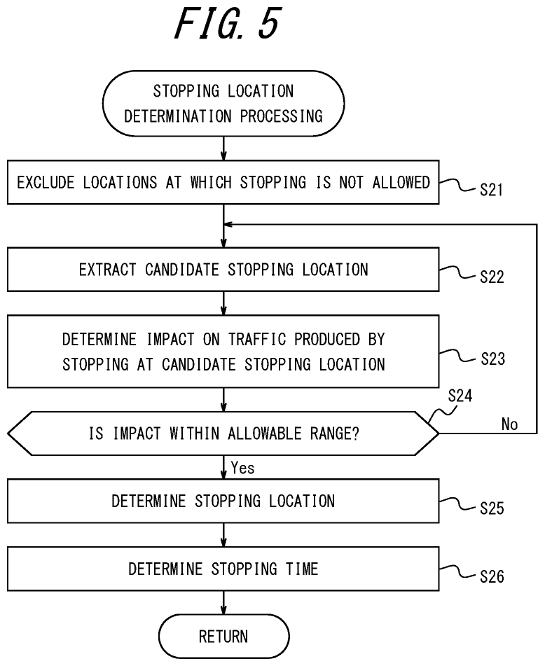

The server controller 12 determines the potential boarding location and the potential alighting location for the user when the user boards the extracted vehicle 20 (Step S14). Once the potential boarding location and the potential alighting location for the user are determined, the potential boarding time and the potential alighting time will be determined. In the determination of the potential boarding location and the potential alighting location for the user, the road condition information is considered. The processing for determining the stopping locations for the vehicle 20 while considering the road condition information will be described with reference to FIG. 5. The stopping locations include both the potential boarding location and the potential alighting location.

Firstly, the server controller 12 extracts any location at which stopping is not allowed in the vicinity of the desired boarding location and the desired alighting location based on the road condition information. Locations at which stopping is not allowed are excluded from candidate stopping locations (Step S21). Locations at which stopping is not allowed include locations at which stopping is prohibited by a road sign included in the regulation information, and locations at which parking is not allowed due to construction, an event, or the like. Locations at which stopping is not allowed further include locations that are determined to have many vehicles parked on the road shoulder based on the congestion information.

The server controller 12 extracts the candidate stopping locations from the route of the vehicle 20, excluding the locations at which stopping is not allowed (Step S22). The server controller 12 extracts, for each of the desired boarding location and the desired alighting location of the user, the candidate stopping locations from nearby locations.

The server controller 12 determines the impact on the traffic produced by stopping at the extracted candidate stopping location (Step S23). Based on the congestion information, the server controller 12 may determine that the larger the congested area and the larger the number of parked vehicles on the road shoulder, the greater the impact on the traffic produced when the vehicle 20 stops. Further, based on the map information, the server controller 12 may determine that the narrower the road, the greater the impact on the traffic produced when the vehicle 20 stops. The server controller 12 may determine that the impact of stopping by the vehicle 20 on the traffic when a parking strip is present is smaller than that when a parking strip is absent.

The server controller 12 evaluates whether the impact on the traffic produced when the vehicle 20 stops is within an allowable range (Step S24). For example, the server controller 12 quantifies the impact on the traffic into a degree of impact. The server controller 12 evaluates the degree of impact based on the congestion information and the map information, and determines that the impact on the traffic produced when the vehicle 20 stops is not within the allowable range in a location or an area in which the degree of impact is greater than a predetermined threshold. When determining that the impact on the traffic produced when the vehicle 20 stops at the candidate stopping location is not within the allowable range (Step S24: No), the server controller 12 returns to the processing in Step S22 and extracts the candidate stopping location again. When determining that the impact on the traffic produced when the vehicle 20 stops at the candidate stopping location is within the allowable range (Step S24: Yes), the server controller 12 determines that the candidate stopping location is to be the stopping location (Step S25). The server controller 12 determines the respective stopping locations corresponding to the desired boarding location and the desired alighting location, which are to be set as the potential boarding location and the potential alighting location.

Further, the server controller 12 determines the stopping times, based on the operation schedule of the vehicle 20 that can be boarded, and the potential boarding location and the potential alighting location (Step S26). The stopping times include the arrival time and the departure time. The potential boarding time and the potential alighting time are determined from the stopping times. The arrival time at the potential boarding location can be the potential boarding time. The arrival time at the potential alighting location can be the potential alighting time.

Upon determining the potential boarding location and the potential alighting location, and the potential boarding time and the potential alighting time for the vehicle 20 that can be boarded in Step S14, the server controller 12 transmits the proposal information to the information terminal 30 (Step S15). The proposal information includes the potential boarding location and the potential alighting location, and the potential boarding time and the potential alighting time for the vehicle 20 that can be boarded. The server controller 12 may transmit a plurality of pieces of the proposal information to the information terminal 30. After transmitting the proposal information to the information terminal 30, the server controller 12 waits for a response from the information terminal 30.

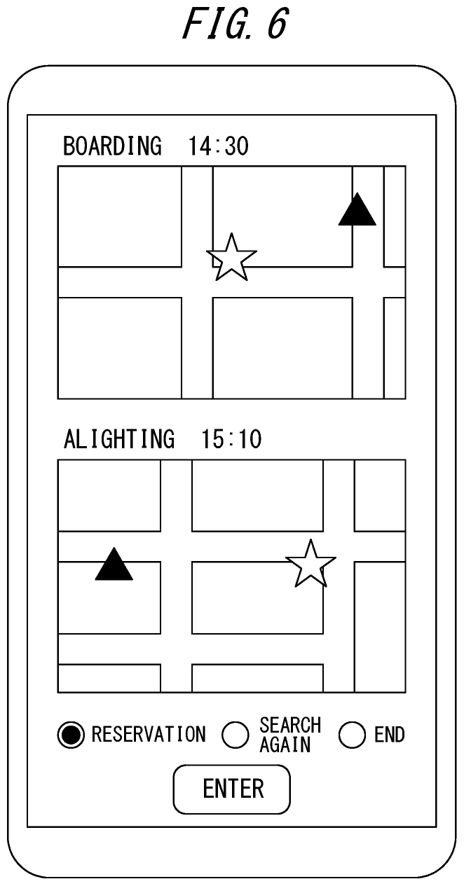

Upon receiving the proposal information from the server 10, the information terminal 30 displays information based on the received proposal information on the input/output interface that is, for example, the touch panel. For example, as illustrated in FIG. 6, the information terminal 30 displays, on the map, the potential boarding location and the potential boarding time, and the potential alighting location and the potential alighting time. The potential boarding location and the potential alighting location may be displayed on the map, along with the desired boarding location and the desired alighting location that have been transmitted as the boarding request information. In FIG. 6, the potential boarding location and the potential alighting location are indicated by white stars. The desired boarding location and the desired alighting location are indicated by black triangles. When the plurality of pieces of proposal information are received from the server 10, the information terminal 30 may display the information in a list format. The information terminal 30 displays a button, a pull-down menu, or the like that urges the user to select whether to board the proposed vehicle 20. For example, in FIG. 6, a “reservation” button is selected to accept the proposal from the server 10 and board the proposed vehicle 20. A “search-again” button is selected when the user does not accept the proposal from the server 10 and wants another proposal. An “exit” button is selected when the user does not accept the proposal from the server 10 and stops using the vehicle dispatch system 1.

In a case in which the user decides to board the proposed vehicle 20 after considering the information displayed on the information terminal 30, the response information indicating acceptance of the proposal information is transmitted from the information terminal 30 to the server 10 by using the application on the information terminal 30. In a case in which the user decides not to board the proposed vehicle 20, the information terminal 30 transmits the response information indicating non-acceptance of the proposal information to the server 10. For example, the user may decide non-acceptance when the potential boarding location is significantly far away from the desired boarding location, or when the potential alighting location is significantly far away from the desired alighting location. Alternatively, the user may decide non-acceptance when the potential boarding time is too far behind the desired boarding time. When the user transmits the response information from the information terminal 30, the server controller 12 receives the response information via the server communication interface 14 (Step S16).

When the response information received from the user's information terminal 30 indicates acceptance of the proposal information, that is, when the user accepts the proposal (Step S17: YES), the server controller 12 establishes the reservation (Step S18). Upon establishing the reservation, the server controller 12 updates the operation schedule information for the vehicle 20 that is stored in the memory of the server 10 or in the DB 15. The server controller 12 establishes the vehicle 20 that can be boarded as included in the proposal information as a boarding vehicle that the user is to board. The server controller 12 establishes the potential boarding location and the potential alighting location, and the potential boarding time and the potential alighting time in the proposal information as the boarding location and the alighting location, and the boarding time and the alighting time, respectively. The server controller 12 reflects the boarding location and the alighting location as the stopping locations in the operation schedule information for the vehicle 20 that is the vehicle that can be boarded. The server controller 12 adjusts the operation schedule of the vehicle 20 as required. The update of the operation schedule information in the server controller 12 is reflected in the operation schedule information for each vehicle 20 at an appropriate timing.

When the response information received from the user's information terminal 30 indicates non-acceptance of the proposal information (Step S17: No), the server controller 12 determines whether to make a proposal to the user again (Step S19). When, for example, the server controller 12 determines to make a search again in response to a user instruction from the information terminal 30 (Step S19: YES), the server controller 12 returns to the processing of Step S13 and repeats the subsequent processing. When, for example, the server controller 12 determines not to make a search again in response to a user instruction from the information terminal 30 (Step S19: No), the server controller 12 ends the processing.

When the reservation has been established in Step S18, the server controller 12 may provide the incentive to the user. The incentive may be provided, for example, by returning a fare for the vehicle 20 to the user. The incentive may be provided, for example, as points that can be used for payment of the fare for the vehicle 20. The incentive may be provided as electronic money. The incentive may be provided as points that can be exchanged for a product or a service. A record of the incentive provided may be stored as the incentive information in association with the user identification information and may be managed by the server controller 12. The incentive information may be stored, for example, in the memory of the server 10, the DB 15, or the like. The user may access his or her own incentive information from the information terminal 30 and check and use the provided incentive.

The server controller 12 may change the level of the incentive that is to be provided to the user depending on various conditions. For example, the server controller 12 can provide the incentive to the user, based on the desired boarding location and the desired alighting location of the user, and the potential boarding location and the potential alighting location. For example, the server controller 12 may provide a higher incentive to the user when a distance between the desired boarding location and the potential boarding location, and a distance between the desired alighting location and the potential alighting location are greater than a predetermined distance. Further, the server controller 12 can provide the incentive to the user, based on the desired boarding time and the desired alighting time, and the potential boarding time and the potential alighting time. For example, the server controller 12 may provide a higher incentive to the user when a difference between the desired boarding time and the potential boarding time is longer than a predetermined time period. This enhances the motivation for the user to reserve the vehicle 20 even if there is a discrepancy between the desire of the user and the proposal of the vehicle dispatch system 1. The usage efficiency of the vehicle 20 is therefore improved.

As has been described, according to the vehicle dispatch system 1 of the present embodiment, the server 10 determines the potential boarding location and the potential alighting location, and the potential boarding time and the potential alighting time for the vehicle 20 that can be used by the user based on a condition of the road. The boarding location and the alighting location can be selected so that the vehicle 20 can avoid locations at which stopping is prohibited, locations at which parking is difficult due to many vehicles parked on a roadside, sections of the road that have a high probability of congestion, etc. This enables the user to board the vehicle 20 and to alight from the vehicle 20 in a smooth manner.

Further, the server 10 can determine the impact on the traffic produced by the vehicle 20 stopping for boarding and alighting of the user, so that the stopping can be accomplished at a location that has a relatively small impact on the traffic. This reduces the impact on the road traffic due to the stopping by the vehicle 20 providing the on-demand service.

Additionally, the present disclosure is not limited to the above embodiment, and various modifications and revisions may be implemented. For example, functions or the like included in each means, each step, or the like can be rearranged without logical inconsistency, and a plurality of means, steps, or the like can be combined together or divided.

1. A server comprising:
a communication interface configured to communicate with an information terminal in the possession of a user; and
a controller configured to manage operation schedule information for one or more vehicles, wherein
the communication interface is configured to receive boarding request information from the information terminal in the possession of the user, the boarding request information including a desired boarding location, a desired alighting location, and a desired boarding time and/or a desired alighting time of the user, and
the controller is configured to determine, for a vehicle that can be used by the user, a potential boarding location and a potential alighting location, and a potential boarding time and a potential alighting time, based on the operation schedule information, the boarding request information, and road condition information indicating a condition of a road in the vicinity of the desired boarding location and the desired alighting location.

2. The server according to claim 1, wherein
the road condition information includes regulatory information related to a regulation for stopping on the road.

3. The server according to claim 1, wherein
the road condition information includes congestion information indicating a congestion condition of the road.

4. The server according to claim 1, wherein
the road condition information includes map information, the map information including information regarding a parking strip, a road width, and/or a road shoulder width.

5. The server according to claim 1, wherein
the controller is configured to determine an impact on traffic on the road produced when the vehicle stops at any location on the road based on the road condition information so as to determine the potential boarding location and the potential alighting location.

6. The server according to claim 1, wherein
the controller is configured to acquire at least part of the road condition information from a camera mounted on the one or more vehicles.

7. The server according to claim 1, wherein
the controller is configured to transmit proposal information to the information terminal via the communication interface, the proposal information including information indicating the determined potential boarding location, the determined potential alighting location, and the determined potential boarding time and/or the determined potential alighting time, and, when response information indicating acceptance of the proposal information has been received from the information terminal, establishes a reservation for the vehicle that can be used.

8. The server according to claim 7, wherein
after establishing the reservation for the vehicle that can be used, the controller determines that an incentive is to be provided to the user, based on the desired boarding location, the desired alighting location, and the desired boarding time and/or the desired alighting time, and the potential boarding location, the potential alighting location, and the potential boarding time and/or the potential alighting time.

9. A vehicle dispatch method comprising:
receiving boarding request information from an information terminal in the possession of a user, the boarding request information including a desired boarding location, a desired alighting location, and a desired boarding time and/or a desired alighting time of the user; and
determining, for a vehicle that can be used by the user, a potential boarding location and a potential alighting location, and a potential boarding time and a potential alighting time, based on operation schedule information for one or more vehicles, the boarding request information, and road condition information indicating a condition of a road in the vicinity of the desired boarding location and the desired alighting location.

10. The vehicle dispatch method according to claim 9, wherein
the road condition information includes regulatory information related to a regulation for stopping on the road.

11. The vehicle dispatch method according to claim 9, wherein
the road condition information includes congestion information indicating a congestion condition of the road.

12. The vehicle dispatch method according to claim 9, wherein
the road condition information includes map information, the map information including information regarding a parking strip, a road width, and/or a road shoulder width.

13. The vehicle dispatch method according to claim 9, further comprising
determining an impact on traffic on the road produced when the vehicle stops at any location on the road based on the road condition information so as to determine the potential boarding location and the potential alighting location.

14. The vehicle dispatch method according to claim 9, further comprising
acquiring at least part of the road condition information from a camera mounted on the one or more vehicles.

15. The vehicle dispatch method according to claim 9, further comprising
transmitting proposal information to the information terminal, the proposal information including information indicating the determined potential boarding location, the determined potential alighting location, and the determined potential boarding time and/or the determined potential alighting time, and, when response information indicating acceptance of the proposal information has been received from the information terminal, establishing a reservation for the vehicle that can be used.

16. The vehicle dispatch method according to claim 15, further comprising,
after establishing the reservation for the vehicle that can be used, determining that an incentive is to be provided to the user, based on the desired boarding location, the desired alighting location, and the desired boarding time and/or the desired alighting time, and the potential boarding location, the potential alighting location, and the potential boarding time and/or the potential alighting time.

17. A non-transitory computer readable medium storing a vehicle dispatch program configured to cause a processor to execute operations comprising:
receiving boarding request information from an information terminal in the possession of a user, the boarding request information including a desired boarding location, a desired alighting location, and a desired boarding time and/or a desired alighting time of the user; and
determining, for a vehicle that can be used by the user, a potential boarding location and a potential alighting location, and a potential boarding time and a potential alighting time, based on operation schedule information for one or more vehicles, the boarding request information, and road condition information indicating a condition of a road in the vicinity of the desired boarding location and the desired alighting location.

18. The non-transitory computer readable medium according to claim 17, wherein
the road condition information includes regulatory information related to a regulation for stopping on the road.

19. The non-transitory computer readable medium according to claim 17, wherein
the road condition information includes congestion information indicating a congestion condition of the road.

20. A vehicle dispatch system comprising:
the server according to claim 1; and
vehicles operation of each of which is managed based on the operation schedule information of the server.
